(19) United States
(12) Patent Application Publication
(10) Pub. No.: US 2017/0336345 A1
(43) Pub. Date: Nov. 23, 2017

(54) GAS SENSOR AND SENSOR APPARATUS

(71) Applicant: FUJITSU LIMITED, Kawasaki-shi (JP)

(72) Inventors: Satoru Momose, Atsugi (JP); Osamu Tsuboi, Kawasaki (JP); Ikuo Soga, Isehara (JP)

(73) Assignee: FUJITSU LIMITED, Kawasaki-shi (JP)

(21) Appl. No.: 15/665,803

(22) Filed: Aug. 1, 2017

Related U.S. Application Data
(63) Continuation of application No. PCT/JP2015/053235, filed on Feb. 5, 2015.

(51) Int. Cl. G01N 27/416; G01N 27/414

(52) U.S. Cl. CPC G01N 27/416; G01N 27/4141

(57) ABSTRACT

A gas sensor includes a p-type semiconductor layer that contains a compound of copper or silver and contacts with detection target gas, a first electrode that is a Schottky electrode to the p-type semiconductor layer, a high-resistance layer that is provided between the p-type semiconductor layer and the first electrode and has resistance higher than that of each of the p-type semiconductor layer and the first electrode, and a second electrode that is an ohmic electrode to the p-type semiconductor layer.

### CROSS-REFERENCE TO RELATED APPLICATION

This application is a continuation application of International Application PCT/JP2015/053235 filed on Feb. 5, 2015 and designated the U.S., the entire contents of which are incorporated herein by reference.

### FIELD

The embodiments discussed herein are related to a gas sensor and a sensor apparatus.

### BACKGROUND

Conventionally, a gas sensor detects gas from a variation of electric current arising from that a sensitive film for which, for example, tin dioxide or the like is used and gas contact with each other.

In such a gas sensor as just described, since current is supplied using a constant current power supply, power consumption is high, and since the gas sensor is heated to a temperature at which a good detection characteristic is obtained, much power is consumed by a heater for heating the gas sensor.

Therefore, also a gas sensor is available in which gas is detected based on a potential difference arising from absorption of gas. For example, in such a gas sensor as just described, an electrode that is reactive and another electrode that is not reactive to detection target gas are provided on both faces of a solid electrolyte layer such that gas is detected based on a potential difference caused by a result of chemical reaction that occurs through contact with gas.

### SUMMARY

According to an aspect of the embodiment, a gas sensor includes a p-type semiconductor layer that contains a compound of copper or silver and contacts with detection target gas, a first electrode that is a Schottky electrode to the p-type semiconductor layer, a high-resistance layer that is provided between the p-type semiconductor layer and the first electrode and has resistance higher than that of each of the p-type semiconductor layer and the first electrode, and a second electrode that is an ohmic electrode to the p-type semiconductor layer.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a schematic sectional view depicting a configuration of a gas sensor according to the present embodiment;

FIG. 2 is a schematic sectional view depicting an example of a configuration of the gas sensor according to the present embodiment;

FIG. 3 is a schematic sectional view depicting a configuration of a modification to the gas sensor according to the present embodiment;

FIG. 4 is a schematic sectional view depicting an example of a configuration of a sensor apparatus including the gas sensor according to the present embodiment;

FIG. 5 is a view depicting an I-V curve of a sensor device of an example 1 within pure nitrogen;

FIG. 6 is a view depicting a variation of a potential difference between electrodes where the sensor device of the example 1 is exposed to nitrogen flow that contains ammonia of a concentration of approximately 1 ppm;

FIG. 7 is a view depicting a variation of drain current where a sensor device in which a sensor device of an example 2 and an FET are integrated is exposed to nitrogen flow that contains ammonia of a concentration of approximately 1 ppm;

FIG. 8 is a view depicting an I-V curve of a sensor device of an example 3 within pure nitrogen;

FIG. 9 is a view depicting a variation of a potential difference between electrodes where the sensor device of the example 3 is exposed to nitrogen flow that contains ammonia of a concentration of approximately 1 ppm;

FIG. 10 is a view depicting an I-V curve of a sensor device of a comparative example within pure nitrogen; and

FIG. 11 is a view depicting a variation of a potential difference between electrodes where the sensor device of the comparative example is exposed to nitrogen flow that contains ammonia of a concentration of approximately 1 ppm.

### DESCRIPTION OF EMBODIMENTS

However, it is difficult for a gas sensor that detects gas on the basis of a potential difference to achieve good sensitivity.

Therefore, it is desired to implement a gas sensor by which power consumption is low and good sensitivity is achieved.

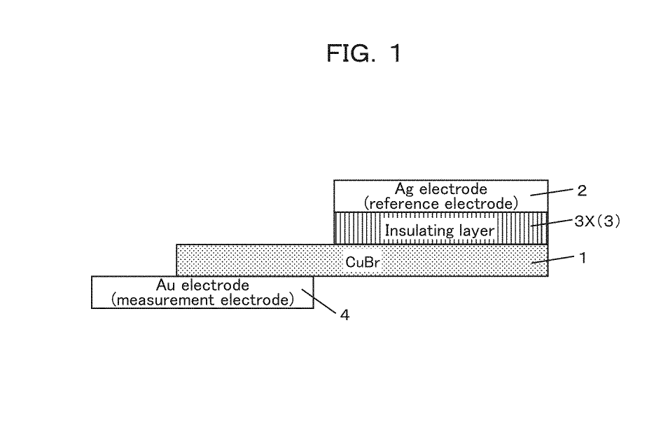

In the following, a gas sensor and a sensor apparatus according to the present embodiment disclosed herein are described with reference to FIGS. 1 to 4.

The gas sensor according to the present embodiment is a gas sensor that detects a chemical substance in gas, particularly, a gas sensor that detects a chemical substance in the atmosphere. For example, it is preferable to apply the present embodiment to a gas sensor that detects a small amount of a chemical substance in expiration.

The gas sensor of the present embodiment is a gas sensor that detects gas on the basis of a potential difference arising from absorption of gas at a temperature near to a room temperature. Therefore, the gas sensor is low in power consumption.

As depicted in FIG. 1, the gas sensor of the present embodiment includes a p-type semiconductor layer 1 that contains a compound of copper or silver and contacts with detection target gas, a first electrode 2 that is a Schottky electrode to the p-type semiconductor layer 1, a high-resistance layer 3 provided between the p-type semiconductor layer 1 and the first electrode 2 and having resistance higher than those of the p-type semiconductor layer 1 and the first electrode 2, and a second electrode 4 that is an ohmic electrode to the p-type semiconductor layer 1. Therefore, good sensitivity is obtained by the gas sensor that detects gas on the basis of a potential difference.

It is to be noted that the gas sensor including the p-type semiconductor layer 1, first electrode 2, high-resistance layer 3 and second electrode 4 is referred to also as gas sensor device. It is to be noted that detection target gas is referred to also as observation target gas.

Here, the p-type semiconductor layer 1 is formed from a p-type semiconductor material that is a compound that contains copper or silver.

For example, where detection target gas is ammonia, it is preferable to use cuprous bromide (cooper (I) bromide; CuBr) that indicates a sharp response to ammonia as the p-type semiconductor material. It is to be noted that an example of a response of cuprous bromide to ammonia is indicated in the form of a significant variation of the electric resistance at a room temperature, for example, in Pascal Lauque et al., “Highly sensitive and selective room temperature NH3 gas microsensor using an ionic conductor (CuBr) film”, Analytica Chimica Acta, Vol. 515, pp. 279-284 (2004), the entire content of which is incorporated herein by reference (hereinafter referred to as technical document).

Since also such a p-type semiconductor material as cuprous oxide (cooper (I) oxide; Cu₂O) that is a compound of copper, silver bromide (AgBr) or silver sulfide (Ag₂O) that is a compound of silver exhibits a reaction to ammonia in a similar mechanism, the p-type semiconductor materials just described can be used similarly to cuprous bromide.

In this manner, it is preferable for the p-type semiconductor layer 1 to contain one selected from a group including cuprous bromide, cuprous oxide, silver bromide and silver sulfide.

Especially, where a semiconductor that is a compound of copper or silver is used as a p-type semiconductor that contacts with detection target gas, a gas sensor can be implemented which has high coordination capacity to ions of copper or silver ion and selectively detects ammonia or amine.

Further, since degradation of the potential difference arising from outflow of charge becomes more likely to occur as the internal resistance of the device decreases, it is advantageous to increase the internal resistance of the device.

Therefore, it is effective to provide a Schottky barrier between the p-type semiconductor layer and one of the electrodes by using a p-type semiconductor material whose work function exceeds that of the electrode material of the one electrode.

Therefore, in the present embodiment, a Schottky barrier is formed between the first electrode 2 and the p-type semiconductor layer 1 such that the work function of the metal material configuring the first electrode 2 is lower than that of the material configuring the p-type semiconductor layer 1, and the first electrode 2 serves as a Schottky electrode to the p-type semiconductor layer 1.

On the other hand, the second electrode 4 and the p-type semiconductor layer 1 are ohmic-coupled to each other such that the work function of the metal material configuring the second electrode 4 is higher than that of the material configuring the p-type semiconductor layer 1, and the second electrode 4 serves as an ohmic electrode to the p-type semiconductor layer 1.

In particular, the first electrode 2 is formed from a material that serves as a Schottky electrode to the p-type semiconductor layer 1 and the second electrode 4 is formed from a material that functions as an ohmic electrode to the p-type semiconductor layer 1.

In this case, the work function of the metal material configuring the first electrode 2 is lower than those of the metal material configuring the second electrode 4 and the material configuring the p-type semiconductor layer 1.

For example, the metal material configuring the first electrode 2 is silver (Ag) and the metal material configuring the second electrode 4 is gold (Au). It is to be noted that the first electrode 2 is referred to also as reference electrode. Further, the second electrode 4 is referred to also as measurement electrode or detection electrode.

Further, in order to further increase the resistance between the p-type semiconductor layer 1 and the first electrode 2 to increase the potential difference between the first electrode 2 and the second electrode 4, the high-resistance layer 3 formed from a material having a resistivity higher than those of the p-type semiconductor layer 1 and the first electrode 2 is provided between the p-type semiconductor layer 1 and the first electrode 2.

Good sensitivity is obtained by providing the high-resistance layer 3 in this manner such that the first electrode 2 side of the p-type semiconductor layer 1 has higher resistance to movement of charge (negative charge) than the second electrode 4 side of the p-type semiconductor layer 1. In other words, good sensitivity is obtained by such a configuration that the coupling between the p-type semiconductor layer 1 and the first electrode 2 has higher resistance to movement of charge (negative charge) than the coupling between the p-type semiconductor layer 1 and the second electrode 4. In this case, the high-resistance layer 3 has higher resistance than the second electrode 4. In short, the high-resistance layer 3 is formed from a material having a resistivity higher than that of the second electrode 4.

Here, the high-resistance layer 3 is a tunnel barrier layer 3X that allows conduction by a tunnel phenomenon. In particular, the tunnel barrier layer 3X is an insulating layer that allows conduction by a tunnel phenomenon. In particular, the tunnel barrier layer 3X is configured by using a material having a resistivity higher than those of the p-type semiconductor layer 1 and the first electrode 2 as an insulating material and setting the thickness of the insulating layer formed from the insulating material to a thickness with which the insulating layer allows conduction by a tunnel phenomenon. In this manner, the p-type semiconductor layer 1 and the first electrode 2 are tunnel-coupled to each other through the tunnel barrier layer 3X.

In this case, it is preferable to select a material for the tunnel barrier layer 3X from among insulating materials and set the thickness of the tunnel barrier layer 3X, for example, to 10 nm or less. This is because, if the thickness is 10 nm or less, then movement of charge across the insulating layer by a tunnel phenomenon is likely to occur.

Further, if a combination of a material configuring the p-type semiconductor layer 1 and a material configuring the first electrode 2, which form Schottky junction if the materials directly contact with each other, is applied, then even if the p-type semiconductor layer 1 and the first electrode 2 directly contact with each other at a defective portion of the tunnel barrier layer 3X, low-resistance coupling between them can be suppressed by the existence of the Schottky barrier and the function of the tunnel barrier layer 3X can be supplemented favorably.

The high-resistance layer 3 is provided partially at one side (here, upper side) of the p-type semiconductor layer 1, and the first electrode 2 is provided on the high-resistance layer 3. In particular, the first electrode 2 contacts with the high-resistance layer 3, and the high-resistance layer 3 contacts with the one side of the p-type semiconductor layer 1. Consequently, the surface of the p-type semiconductor layer 1 is exposed partially so as to contact with detection target gas. On the other hand, the second electrode 4 is provided at the other side (here, lower side) of the p-type semiconductor layer 1. In particular, the second electrode 4 contacts with the surface of the other side of the p-type semiconductor layer 1.

In this manner, the first electrode 2 is coupled to the p-type semiconductor layer 1 through the high-resistance layer 3. In other words, the high-resistance layer 3 is provided between the first electrode 2 and the p-type semiconductor layer 1. Consequently, the gas sensor of the present embodiment is configured so as to have capacitance between the first electrode 2 and the p-type semiconductor layer 1. In particular, a capacitor is configured from the first electrode 2, high-resistance layer 3 and p-type semiconductor layer 1. On the other hand, the second electrode 4 is directly coupled to the p-type semiconductor layer 1. Consequently, good sensitivity is obtained. Especially, since the capacitor allows conduction, namely, has some leak, the influence of noise such as electrostatic noise can be reduced and the S/N ratio can be improved.

It is to be noted that, even if the p-type semiconductor layer 1 and the first electrode 2 are Schottky coupled to each other such that a Schottky barrier is formed therebetween without providing the high-resistance layer 3 between them, gas detection operation can be performed in principle. This is because a depletion layer appearing in the inside of a semiconductor as a result of the Schottky coupling can be configured so as to indicate high resistance in a low-voltage region and the charge can pass through the depletion layer by tunneling. However, the value of the electric resistance provided by the depletion layer has a constraint for each material to be used and is not capable of being freely set to a preferable value. Further, since the concentration of positive holes that diffuse from the depletion layer of the p-type semiconductor layer 1 to the first electrode 2 depends much upon the temperature, the resulting device is hypersensitive to a temperature variation and is likely to accept noise. Therefore, it is advantageous to configure the device using the high-resistance layer 3 (here, tunnel barrier layer 3X) that allows conduction by tunneling as described above in that the possibility is higher that the detection characteristic may be optimized.

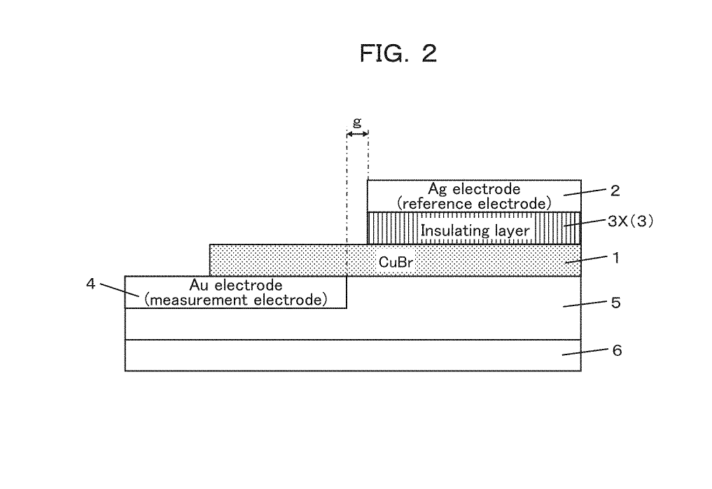

In particular, as depicted in FIG. 2, the gas sensor (sensor device) may be configured such that a gold electrode (Au electrode) as the second electrode (measurement electrode) 4 is provided on a silicon substrate 6 having an SiO₂ film 5; a cuprous oxide layer (CuBr layer) as the p-type semiconductor layer 1 is provided on the gold electrode (Au electrode); a lithium fluoride layer (LiF layer) as the high-resistance layer 3 (tunnel barrier layer 3X) is provided on the cuprous oxide layer (CuBr layer); and a silver electrode (Ag electrode) as the first electrode 2 is provided on the lithium fluoride layer (LiF layer).

It is to be noted here that, while the high-resistance layer 3 is the tunnel barrier layer 3X formed from an insulating material, the high-resistance layer 3 is not limited to this.

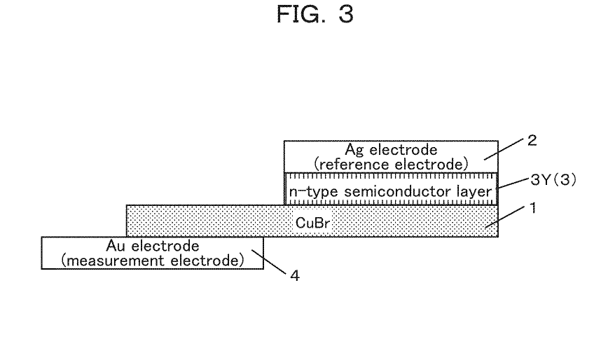

For example, as depicted in FIG. 3, the high-resistance layer 3 may be an n-type semiconductor layer 3Y having a work function lower than those of the p-type semiconductor layer 1 and the first electrode 2. In particular, a material having a resistivity higher than those of the p-type semiconductor layer 1 and the first electrode 2 may be used as an n-type semiconductor material that indicates a work function lower than work functions of the p-type semiconductor layer 1 and first electrode 2 such that the high-resistance layer 3 is configured from the n-type semiconductor layer 3Y that is formed from the n-type semiconductor material.

It is to be noted that, even if the high-resistance layer 3 is the tunnel barrier layer 3X formed from an insulating material or is the n-type semiconductor layer 3Y having a work function lower than those of the p-type semiconductor layer 1 and the first electrode 2, the high-resistance layer 3 has high resistance to movement of charge (negative charge) and suppresses movement of charge (negative charge). Therefore, the high-resistance layer 3 is referred to also as charge movement suppression layer (negative charge movement suppression layer).

In this manner, if the high-resistance layer 3 is configured as the n-type semiconductor layer 3Y and the work function of a material configuring the n-type semiconductor layer 3Y is lower than those of the materials configuring the p-type semiconductor layer 1 and the material configuring the first electrode 2 that contact with the n-type semiconductor layer 3Y, then movement of the negative charge from the material configuring the p-type semiconductor layer 1 to the metal material configuring the first electrode 2 becomes difficult. Therefore, operation similar to that where the tunnel barrier layer 3X formed from an insulating material is used for the high-resistance layer 3 is exhibited.

However, if the n-type semiconductor material contacts with the p-type semiconductor material, then generally a depletion layer is formed at the interface of them by supplying electrons to the p-type semiconductor material. In the present embodiment, gas molecules are adsorbed to the surface of the p-type semiconductor layer 1 and movement of electrons within the p-type semiconductor layer 1 is performed. Consequently, since the carrier concentration in the inside of the p-type semiconductor layer 1 varies together with detection operation and also the thickness of the depletion layer varies together with the variation, also the resistance value across the n-type semiconductor layer 3Y varies significantly.

Therefore, where, in the n-type semiconductor material used here, the carrier concentration is insufficient when the depletion layer is formed in the inside of the p-type semiconductor layer 1, operation is simpler, and therefore, the material can be handled easily. Here, a material of a group that has an n-type conductivity and is low in carrier concentration is used for an electron transport layer of an electroluminescence (EL) device and is called electron transport material.

Where the electron transport layer for which such an electron transport material as just described is used is used as the n-type semiconductor layer 3Y, if the work function of the electron transport layer 3Y is lower than that of the p-type semiconductor layer 1, then the electron transport layer 3Y functions as a simple insulating layer. Therefore, electrical operation in the inside of the p-type semiconductor layer 1 is similar to that where the insulating layer 3X for which an insulating material is used is used.

On the other hand, if the work function of the electron transport layer 3Y is equal to or higher than that of the first electrode 2, then the first electrode 2 and the electron transport layer 3Y are ohmic-coupled to each other. Therefore, the thickness of a region that operates as an insulating layer decreases and movement of charge between the p-type semiconductor layer 1 and the first electrode 2 becomes easy. Therefore, loss occurs in the potential difference generated by detection operation. Accordingly, also where the electron transport layer 3Y for which an electron transport material is used is used, a configuration is applied such that the work function of the electron transport layer 3Y is lower than that of the first electrode 2.

For example, where silver, gold and cuprous bromide are used as the material configuring the first electrode 2, material configuring the second electrode 4 and material configuring the p-type semiconductor layer 1, respectively, since bathocuproin whose work function is approximately 3.5 eV can increase the difference in work function and can further improve the sensitivity, bathocuproin is preferable as an electron transport material that configures the electron transport layer (n-type semiconductor layer) 3Y as the high-resistance layer 3. Further, also such electron transport materials as various oxadiazole derivatives, various triazole derivatives and tris (8-hydroxyquinolinolato) aluminum can be used similarly as an electron transport material configuring the electron transport layer 3Y as the high-resistance layer 3.

Further, it is preferable for the first electrode 2 and the second electrode 4 to contain a metal material having an ionization tendency lower than that of a metal element contained in the p-type semiconductor layer 1. In particular, it is preferable to form the first electrode 2 and the second electrode 4 from a metal material nobler than a metal element contained in the p-type semiconductor layer 1. By this, the durability can be improved.

It is to be noted that, since a solid electrolyte having been practically used in a conventional gas sensor for detecting gas on the basis of the potential difference is heated by a heater because the temperature with which a sufficient ion conductivity is obtained is as high as approximately 500° C., and therefore, the power consumption of the heater is very high.

In contrast, if the p-type semiconductor layer 1 containing a compound of copper or silver as described above is used and such a configuration as described above is applied, then a potential difference detection gas sensor that can indicate good detection sensitivity at a room temperature and is low in power consumption can be implemented.

Especially, since a method for measuring the potential difference appearing in the inside of the device through contact with gas is adopted, current supply from the outside is not required, which is advantageous in power saving. Further, good detection sensitivity can be obtained by such a configuration that spontaneous polarization occurs in the device through contact with gas. Since the potential difference spontaneously occurring as a result of doping of electrons from gas molecules into the semiconductor and carrier movement directly caused by the doping is used in this manner, the device need not be heated and measurement can be performed with good detection sensitivity using a simple circuit having low power consumption. Especially, the S/N ratio can be improved and the influence of noise such as electrostatic noise can be reduced.

In the following, operation of the gas sensor configured in such a manner as described above is described where the material of the p-type semiconductor layer 1 is cuprous bromide (CuBr); the observation target gas is ammonia; the material of the first electrode 2 is silver (Ag); the material of the second electrode 4 is gold (Au); and the high-resistance layer 3 is formed from the tunnel barrier layer 3X (refer to FIGS. 1 and 2).

It is to be noted that, if a CuBr layer is formed by the method disclosed in the technical document mentioned hereinabove, then where gold (work function of approximately 5.1 eV) is used for the electrode, the electrode serves as an ohmic electrode to the CuBr layer, but where silver (work function of approximately 4.3 eV) having a lower work function is used for the electrode, the electrode serves as a Schottky electrode to the CuBr layer.

If ammonia is adsorbed to the surface of the CuBr layer that is the p-type semiconductor layer 1, then electrons are doped from ammonia molecules having the reduction ability into the CuBr.

If positive holes in the CuBr become insufficient by the doping of electrons, then since negative charge is discharged to the second electrode 4 (Au electrode) that is an ohmic electrode, the potential of the second electrode 4 decreases.

On the other hand, since the tunnel barrier layer 3X as the high-resistance layer 3 exists between the first electrode 2 that is a Schottky electrode (Ag electrode) and the CuBr layer 1 and the resistance is much higher than that between the second electrode 4 and the CuBr layer 1, a potential difference occurs between the first electrode 2 and the second electrode 4 and the potential of the first electrode 2 becomes higher than that of the second electrode 4.

The amount of charge to be doped into a semiconductor by one molecule of ammonia is determined for each semiconductor material that is a target, and the amount of ammonia to be adsorbed to the surface of the semiconductor per unit time increases, in a low-concentration region, in proportion to the ammonia concentration in the atmosphere.

Here, if charge that flows into the CuBr layer 1 by electron movement from ammonia is represented by Qᵢₙ; the tunnel resistance is represented by R because it follows the Ohm's law; the capacitance of the capacitor formed by the tunnel barrier layer 3X is represented by C; and the potential difference across the tunnel barrier layer 3X is represented by V, then in an initial variation when measurement is started in a state in which the system is in an equilibrium state, where the sign of the charge doped in CuBr is taken into consideration, the relationship given below is satisfied:

C·dV/dt=dQᵢₙ/dt+V/R (1)

Therefore, the following relationship is satisfied:

C·dV/dt−V/R∝ammonia concentration (2)

Accordingly, the relationship given above can be described, using constants A and B (here, A assumes a negative value), as

C·dV/dt−V/R=A×ammonia concentration+B (3)

If V where the ammonia concentration is 0 is represented by V₀, then the expression (3) above can be represented by the following expression:

Ammonia concentration=(C·dV/dt+(V₀−V)/R)/A (4)

In particular, the ammonia concentration can be measured using a proportional relationship between the ammonia concentration and the potential difference across the tunnel barrier layer 3X by applying a configuration that a capacitor that leaks current with a fixed electric resistance is provided between the semiconductor and the electrode.

More particularly, by observing the potential difference across the tunnel barrier layer 3X provided between the semiconductor and the electrode and the time variation of the potential difference, the ammonia concentration can be determined, and, if measurement is performed at an initial stage at which the variation of the potential V is very small, then the ammonia concentration can be estimated only from the time variation of the potential difference.

Further, while also the resistance in the inside of the CuBr layer 1 varies through contact with ammonia, if a configuration for increasing the impedance of the measurement system and reducing the current to flow to the circuit to a very low level, then the fluctuation of the potential difference by variation of the resistance of the CuBr layer 1 can be suppressed.

Further, if measurement is performed after the equilibrium state is established after contact with detection target gas (measurement target gas) is started, then the ammonia concentration can be determined only from the potential difference. It is to be noted that the equilibrium state here signifies a state in which entering and leaving charge by absorption and desorption of gas and charge lost by short-circuiting by tunnel current are balanced, and it is not appropriate to use the expressions (1) to (4) given above that describe a state immediately after starting of absorption of gas as they are.

It is to be noted that, as the resistance value of a junction portion between the CuBr layer 1 and the first electrode 2 increases, the maximum value of a potential difference variation increases and the sensitivity increases as indicated by the expression (4) described above, and therefore, where high sensitivity is demanded, a capacitance appears at the portion. Further, where the capacitance at the portion is 0, since the resistance value of the coupling portion is low, the maximum value of the potential difference signal decreases, and since the left side of the expression (1) given hereinabove becomes 0, a maximum potential difference is observed in an initial variation in which the absorption speed of gas molecules is highest and the potential difference signal thereafter exhibits gradually decreasing operation. Consequently, the disadvantage gives rise that difficulty in measurement increases from that in the operation that the potential difference signal gradually increases where the capacitance exists.

By measuring the potential difference between the first electrode 2 as a reference electrode and the second electrode 4 as a detection electrode by the principle described above, the concentration of the detection target gas can be measured.

It is to be noted that, where the tunnel resistance R is higher, the potential difference when the equilibrium state is reached is greater. Further, from the expression (4) given above, where the capacitance C becomes lower, a rising edge (negative direction) of a signal becomes sharper. Since the resistance becomes higher but the capacitance becomes lower as the thickness of the tunnel barrier layer 3X become larger, this is advantageous in terms of the detection sensitivity. However, if the thickness of the tunnel barrier layer 3X becomes excessively great, then the capacitor becomes a mere capacitor and the potential difference between the electrodes comes to depend much upon the amount of charge entering and leaving an external measurement circuit. Therefore, technical difficulty of the measurement increases, which is not preferable. Therefore, the range of a preferable thickness of the tunnel barrier layer 3X practically is approximately 1 to 10 nm.

Accordingly, with the gas sensor according to the present embodiment, there is an advantage that the power consumption can be reduced and good sensitivity can be obtained. In short, a gas sensor having high sensitivity and low power consumption can be implemented.

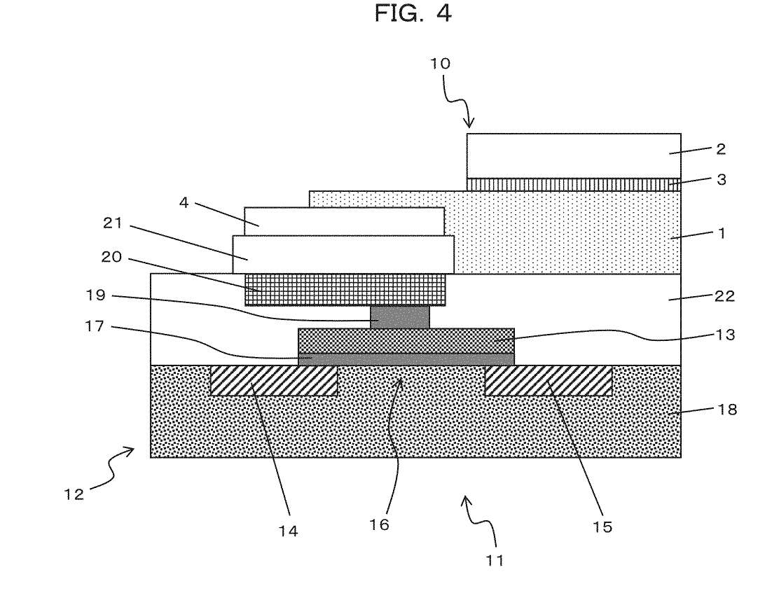

Incidentally, also it is possible to configure a sensor apparatus 12 by coupling a detection unit 11 for detecting the potential difference between the first electrode 2 and the second electrode 4 of the gas sensor 10 of the embodiment described above to the gas sensor 10 of the embodiment described above (for example, refer to FIG. 4).

In this case, the sensor apparatus 12 according to the present embodiment includes the gas sensor 10 of the embodiment described above and the detection unit 11 that is coupled to the gas sensor 10 and detects the potential difference between the first electrode 2 and the second electrode 4 of the gas sensor 10.

Here, where the gas sensor 10 of the embodiment described above is used, the detection unit 11 is coupled to the second electrode 4 of the gas sensor 10.

Further, it is preferable to configure the detection unit 11 using a field-effect type transistor (FET) in that the size of the sensor apparatus 12 can be reduced and the variation of the potential difference that is an output signal from the gas sensor 10 can be amplified.

For example, as the field-effect type transistor (detection unit) 11, a field-effect type transistor or the like is available which includes a gate electrode 13 for applying a gate voltage, a source electrode 14 and a drain electrode 15 for extracting current, an active layer (active region) 16 provided between the source electrode 14 and the drain electrode 15, and a gate insulating layer 17 provided between the gate electrode 13 and the active layer 16. In this case, as a material of the active layer 16, for example, silicon, a metal oxide semiconductor and so forth are available. To the gate electrode 13 of the field-effect type transistor 11 configured in this manner, the second electrode 4 of the gas sensor 10 of the embodiment described above is coupled.

In particular, the sensor apparatus 12 including the gas sensor 10 of the embodiment described above and the field-effect type transistor 11 may be configured as an apparatus in which they are integrated as described below.

For example, as depicted in FIG. 4, the gas sensor 10 includes a p-type semiconductor layer 1 (CuBr layer; approximately 200 nm thick), a high-resistance layer 3 (lithium fluoride layer; approximately 1 nm thick), a first electrode 2 (Ag electrode; approximately 80 nm thick) and a second electrode 4 (Au electrode; approximately 60 nm thick). Here, the first electrode 2 is provided at a portion other than a gas contacting portion, with which detection target gas contacts, at one side (here, upper face) of the p-type semiconductor layer 1 across the high-resistance layer 3. The second electrode 4 is provided at the other side (here, lower face) of the p-type semiconductor layer 1.

The field-effect type transistor 11 includes a silicon substrate 18 including the active layer 16, the source electrode 14, the drain electrode 15, the gate insulating layer 17 (silicon oxide insulating layer) and the gate electrode 13 (N type polysilicon; N type p-si) (nMOS-FET). The source electrode 14 and the drain electrode 15 are provided across the active layer 16. The gate insulating layer 17 is provided between the active layer 16 and the gate electrode 13.

The second electrode 4 of the gas sensor 10 and the gate electrode 13 of the field-effect type transistor 11 are coupled to each other through a first interconnection 19 (tungsten interconnection), a second interconnection 20 (Al—Cu—Si interconnection) and an electrode pad 21 (Al pad). Further, an insulating layer 22 (silicon oxide insulating layer) is formed so as to cover the gate insulating layer 17, gate electrode 13, first interconnection 19 and second interconnection 20, and the gas sensor 10 is provided on the insulating layer 22.

### EXAMPLES

The embodiment is described in more detail in connection with examples. However, the present technology is not limited to the examples described below.

### Example 1

In the example 1, a gold electrode having a width of approximately 6 mm, a length of approximately 20 mm and a thickness of approximately 60 nm was formed as the second electrode 4 by vacuum deposition on a silicon wafer with a thermal oxide film (silicon substrate) 6 having a length of approximately 50 mm and a width of approximately 10 mm and having a thermal oxide film (SiO₂ film) 5 that has a thickness of approximately 1 μm on the surface thereof. Then, cuprous bromide (CuBr) as the p-type semiconductor layer 1 having a thickness of approximately 200 nm was formed by sputtering using a mask so as to have a shape of a width of approximately 8 mm, a length of approximately 30 mm and a thickness of approximately 60 nm (refer to FIG. 2). Further, lithium fluoride (LiF) that is an insulating material having a thickness of approximately nm was formed as the tunnel barrier layer 3X (high-resistance layer 3; insulating layer that allows conduction by a tunnel phenomenon) by vacuum deposition, and then a silver electrode having a thickness of approximately 80 nm was formed as the first electrode 2 by vacuum deposition to produce a sensor device (gas sensor) (refer to FIG. 2).

Here, the plane size of the tunnel barrier layer 3X and the first electrode 2, namely, the plane size of a stacked film of lithium fluoride and silver, was determined to a width of approximately 10 mm and a length of approximately 20 mm, and a gap length (indicated by reference character g in FIG. 2) that is a distance between an end of the first electrode 2 and an end of the second electrode 4 was determined to approximately 0.5 mm.

The 196 system DMM produced by Keithley was coupled to the sensor device produced in such a manner as described above such that the second electrode 4 serves as a detection electrode (action electrode) and the first electrode 2 serves a reference electrode so as to allow measurement of the potential difference between the electrodes.

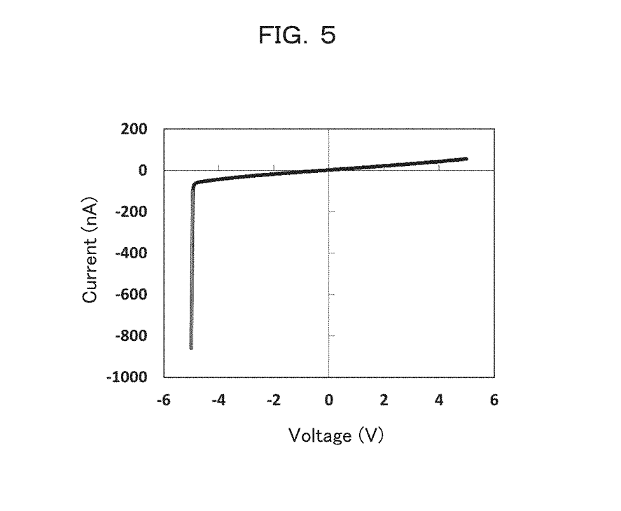

Here, FIG. 5 depicts an I-V curve measured in pure nitrogen at a room temperature (approximately 23° C.). It is to be noted that the measurement was performed by sweeping of the work electrode 4 in a direction from the negative to the positive.

As depicted in FIG. 5, since charging operation is found at an initial stage of the measurement, it is recognized that the sensor device has a character as a capacitor and that it has a function also as a capacitor in which the voltage and the current have a proportional relationship to each other except the charging operation and which serves also as a resistor having a resistance value of approximately 100 MΩ and involves fixed leakage.

Thereafter, the response of the sensor device to ammonia was evaluated by installing the sensor device in a flow path of nitrogen gas and changing over the gas source between pure nitrogen and nitrogen containing ammonia of a concentration of approximately 1 ppm at a room temperature (approximately 23° C.)

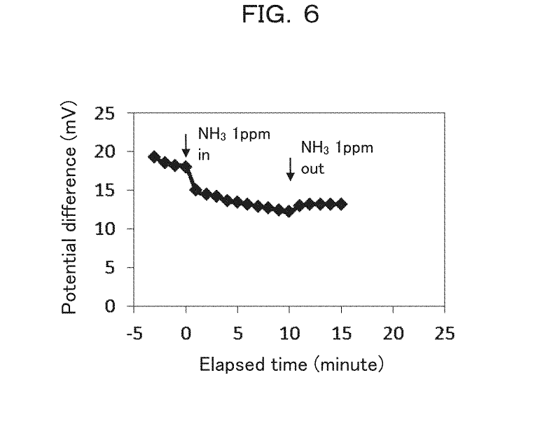

FIG. 6 depicts a time variation of a measured potential difference regarding reaction to ammonia.

As depicted in FIG. 6, when the gas flow was changed over from pure nitrogen to nitrogen that contains ammonia of a concentration of approximately 1 ppm, the potential of the second electrode 4 decreased by approximately 7 mV, and, when the gas flow was changed over to pure nitrogen, the potential recovered.

By configuring the sensor device such that it includes the p-type semiconductor layer 1 (here, CuBr) that contains copper and contacts with detection target gas (here, ammonia), the first electrode 2 (here, Ag electrode) that serves as a Schottky electrode to the p-type semiconductor layer 1, the second electrode 4 (here, Au electrode) that serves as an ohmic electrode to the p-type semiconductor layer 1 and the tunnel barrier layer 3X (here, lithium fluoride layer) as the high-resistance layer 3 provided between the p-type semiconductor layer 1 and the first electrode 2 and having resistance higher than those of the p-type semiconductor layer 1 and the first electrode 2, the potential difference measurement type gas sensor having high sensitivity was implemented successfully.

### Example 2

In the example 2, the sensor apparatus 12 structured such that the second electrode 4 of the gas sensor 10 configured in such a manner as in the example 1 is coupled to the gate electrode 13 of the FET 11 was generated (refer to FIG. 4).

Here, the width of each of the first electrode 2, second electrode 4 and p-type semiconductor layer 1 (detection layer) formed from cuprous bromide of the gas sensor 10 was approximately 0.8 mm, and the gap length between the first electrode 2 and the second electrode 4 was approximately 0.5 mm. Further, the length of a portion at which the first electrode 2 and the p-type semiconductor layer 1 formed from cuprous bromide overlap with each other was approximately 0.8 mm, and the length of a portion at which the second electrode 4 and the p-type semiconductor layer 1 formed from cuprous bromide overlap with each other was approximately 0.6 mm.

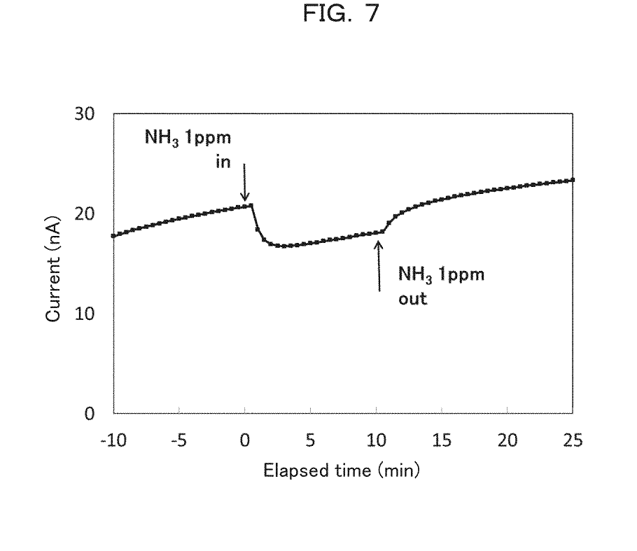

When the sensor apparatus 12 produced in such a manner as described was placed into a flow path of nitrogen gas and the gas source was changed over between pure nitrogen and nitrogen containing ammonia of a concentration of approximately 1 ppm at a room temperature (approximately 23° C.), such a variation of drain current as depicted in FIG. 7 was found under a condition of the back gate voltage of −5 V.

As depicted in FIG. 7, drain current just before introduction of ammonia was approximately 20.8 nA and the minimum drain current value in the ammonia gas flow was approximately 16.7 nA, and the ratio of the current variation by ammonia of a concentration of approximately 1 ppm was approximately 20%.

By configuring the sensor apparatus 12 so as to include the gas sensor 10 of a high-sensitive potential difference measurement type and the FET 11 in this manner, it was possible to amplify a variation of the potential difference measured in high sensitivity and obtain the variation as a current variation by the gas sensor 10 and thereby implement a sensor apparatus of a reduced size.

### Example 3

In the example 3, a sensor device was produced similarly as in the example 1 by forming a film of bathocuproin that is an electron transport material having a thickness of approximately 8 nm by vacuum deposition to form an electron transport layer (n-type semiconductor layer having a work function lower than those of the p-type semiconductor layer 1 and the first electrode 2) 3Y as the high-resistance layer 3 in place of the tunnel barrier layer 3X (lithium fluoride that is an insulating material) provided in the sensor device of the example 1 (for example, refer to FIG. 3).

196 system DMM of Keithley was coupled to the sensor device produced in such a manner as described above such that the second electrode 4 serves as the detection electrode (working electrode) and the first electrode 2 serves as the reference electrode such that the potential difference between the electrodes can be measured.

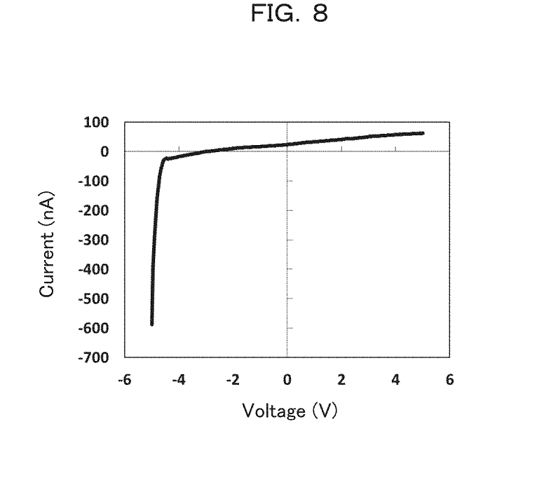

Here, FIG. 8 depicts an I-V curve measured within pure nitrogen at a room temperature (approximately 23° C.). It is to be noted that the measurement was performed by sweeping of the work electrode 4 in a direction from the negative to the positive.

Since power charging operation is found at an initial stage of the measurement as depicted in FIG. 8, it is recognized that the sensor device has a character as a capacitor and that it has a function also as a capacitor in which the voltage and the current have a proportional relationship to each other except the charging operation and which serves also as a resistor having a resistance value of approximately 150 MΩ and involves fixed leakage.

Then, similarly as in the example 1, response of the sensor device to ammonia was evaluated by placing the sensor device into the flow path of nitrogen gas and changing over the gas source between pure nitrogen and nitrogen that contains ammonia of a concentration of approximately 1 ppm.

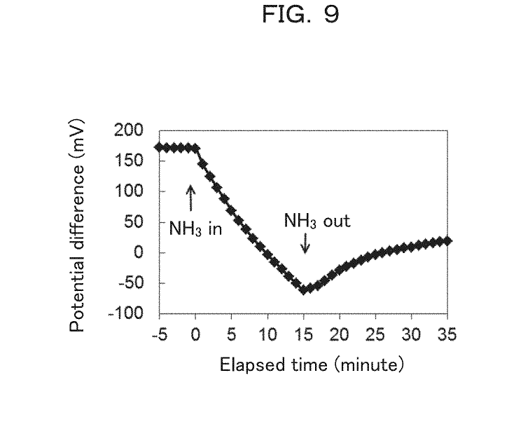

FIG. 9 depicts a time profile of response of a measured potential difference to ammonia.

As depicted in FIG. 9, when the gas flow was changed over from pure nitrogen to nitrogen that contains ammonia of a concentration of approximately 1 ppm, the potential of the detection electrode decreased by approximately 230 mV, and, when the gas flow was changed over to pure nitrogen, the potential recovered.

By configuring the sensor device such that it includes the p-type semiconductor layer 1 (here, CuBr) that contains copper and contacts with detection target gas (here, ammonia), the first electrode 2 (here, Ag electrode) that serves as a Schottky electrode to the p-type semiconductor layer 1, the second electrode 4 (here, Au electrode) that serves as an ohmic electrode to the p-type semiconductor layer 1, and the high-resistance layer 3 provided between the p-type semiconductor layer 1 and the first electrode 2 and having resistance higher than those of the p-type semiconductor layer 1 and the first electrode 2 (n-type semiconductor layer 3Y having a work function lower than those of the p-type semiconductor layer and the first electrode; here, a bathocuproin layer), the gas sensor of the potential difference measurement type having high sensitivity was implemented successfully.

### COMPARATIVE EXAMPLE

In the comparative example, a sensor device was produced similarly as in the examples 1 and 3 without providing the tunnel barrier layer 3X or the n-type semiconductor layer 3Y as the high-resistance layer 3.

Here, a plane size of a silver electrode as the first electrode 2 has a width of approximately 10 mm and a length of approximately 20 mm, and a gap length that is a distance between an end of the first electrode 2 and an end of the second electrode 4 was approximately 1 mm.

196 system DMM of Keithley was coupled to the sensor device produced in such a manner as described above such that the second electrode 4 serves as the detection electrode (working electrode) and the first electrode 2 serves as the reference electrode so as to allow measurement of the potential difference between the electrodes similarly as in the examples 1 and 3.

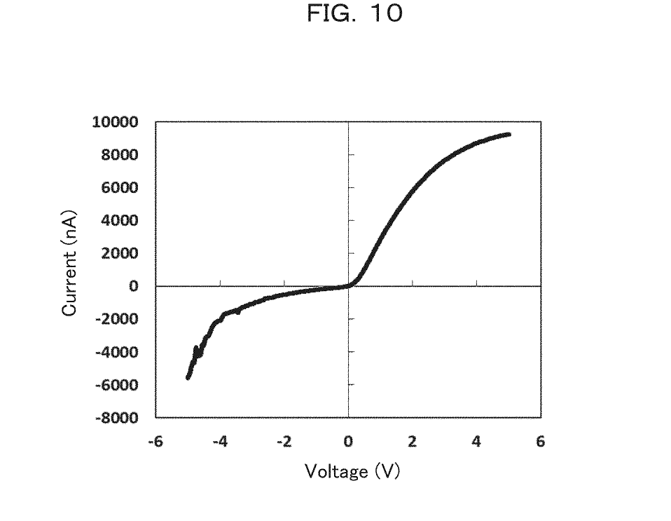

Here, FIG. 10 depicts an I-V curve measured within pure nitrogen at a room temperature (approximately 23° C.). It is to be noted that the measurement was performed by sweeping of the work electrode 4 in a direction from the negative to the positive.

As depicted in FIG. 10, it is recognized that power accumulation operation is not found and the sensor device has a function as an incomplete diode in which a Schottky barrier is provided on an interface between the p-type semiconductor layer 1 (here, CuBr) and the first electrode 2 (here, a silver electrode). The resistance value of the sensor device was approximately 280 kΩ at approximately 0.5 V.

Then, similarly as in the example 1, reaction of the sensor device to ammonia was evaluated by placing the sensor device into the flow path of nitrogen gas and changing over the gas source between pure nitrogen and nitrogen that contains ammonia of a concentration of approximately 1 ppm at a room temperature (approximately 23° C.)

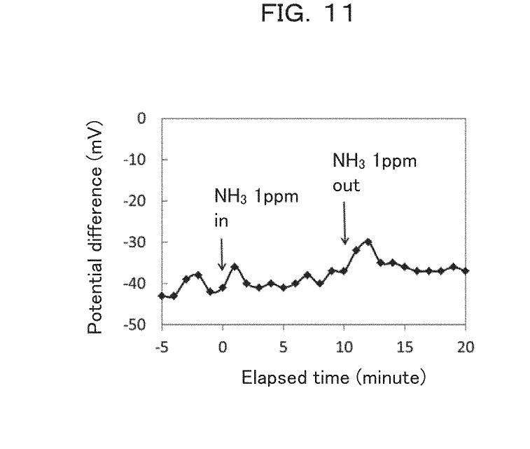

FIG. 11 depicts a time variation of a measured potential difference regarding reaction to ammonia.

As depicted in FIG. 11, the potential difference did not indicate a clear variation not only in a case in which the gas flow was changed over from pure nitrogen to nitrogen that contains ammonia of a concentration of approximately 1 ppm and but also in a case in which the gas flow was changed over from nitrogen that contains ammonia to pure nitrogen. It was found that, since the resistance value between the p-type semiconductor layer (here, CuBr) and the first electrode (here, a silver electrode) is low and also the capacitance is low, the sensor device of the comparative example does not function as a sensor device.

Where the sensor device was configured such that, although it includes the p-type semiconductor layer 1 (here, CuBr) containing copper and contacting with detection target gas (here, ammonia), first electrode 2 (here, Ag electrode) that serves as a Schottky electrode to the p-type semiconductor layer 1, second electrode 4 (here, Au electrode) that serves as an ohmic electrode to the p-type semiconductor layer 1, it does not include high-resistance layer 3 (tunnel barrier layer 3X or n-type semiconductor layer 3Y having a work function lower than those of the p-type semiconductor layer 1 and first electrode 2) between the p-type semiconductor layer 1 and the first electrode 2, it was difficult to implement a high-sensitive gas sensor of the potential difference measurement type.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A gas sensor, comprising:
a p-type semiconductor layer that contains a compound of copper or silver and contacts with detection target gas;
a first electrode that is a Schottky electrode to the p-type semiconductor layer;
a high-resistance layer that is provided between the p-type semiconductor layer and the first electrode and has resistance higher than that of each of the p-type semiconductor layer and the first electrode; and
a second electrode that is an ohmic electrode to the p-type semiconductor layer.

2. The gas sensor according to claim 1, wherein the high-resistance layer is an insulating layer that allows conduction by a tunnel phenomenon.

3. The gas sensor according to claim 1, wherein the high-resistance layer is an n-type semiconductor layer having a work function lower than that of each of the p-type semiconductor layer and the first electrode.

4. The gas sensor according to claim 1, wherein the p-type semiconductor layer contains one selected from a group including cuprous bromide, cuprous oxide, silver bromide and silver sulfide.

5. The gas sensor according to claim 1, wherein the first electrode and the second electrode contain a metal material having an ionization tendency lower than that of a metal element contained in the p-type semiconductor layer.

6. A sensor apparatus, comprising:
a gas sensor including:
a p-type semiconductor layer that contains a compound of copper or silver and contacts with detection target gas;
a first electrode that is a Schottky electrode to the p-type semiconductor layer;
a high-resistance layer that is provided between the p-type semiconductor layer and the first electrode and has resistance higher than that of each of the p-type semiconductor layer and the first electrode; and
a second electrode that is an ohmic electrode to the p-type semiconductor layer; and
a detection unit that is coupled to the gas sensor and detects a potential difference between the first electrode and the second electrode of the gas sensor.

7. The sensor apparatus according to claim 6, wherein the detection unit is a field effect transistor.
